(19) United States
(12) Patent Application Publication
(10) Pub. No.: US 2025/0351868 A1
(43) Pub. Date: Nov. 20, 2025

(54) A SHEET OF AEROSOL GENERATING MATERIAL FOR A COMPONENT OF AN ARTICLE AND APPARATUS AND METHOD FOR FORMING THE SHEET

(71) Applicant: NICOVENTURES TRADING LIMITED, London (GB)

(72) Inventors: Daniel BRAY, London (GB); Jeong Hwan PARK, London (GB); Richard LEBBON, London (GB)

(21) Appl. No.: 19/120,397

(22) PCT Filed: Oct. 20, 2023
(86) PCT No.: PCT/GB2023/052740

§ 371 Date: Apr. 11, 2025

(30) Foreign Application Priority Data
Oct. 21, 2022 (GB) 2215641.8

(51) Int. Cl. A24D 1/20; A24C 5/01; A24C 5/18

(52) U.S. Cl. CPC A24D 1/20; A24C 5/01; A24C 5/1828

(57) ABSTRACT

An article includes a rod of aerosol generating material. The rod of aerosol generating material is formed from a plurality of elongate strips of aerosol generating material extending longitudinally through said rod. Each of the plurality of elongate strips is connected to at least one other of the plurality of elongate strips by a connection portion. The connecting portion includes over 20% of the length of each elongate strip. The invention also relates to a method of forming a rod of aerosol generating material of an article. The invention also relates to an apparatus for manufacturing rods of aerosol generating material of an article.

### RELATED APPLICATIONS

The present application is a National Phase entry of PCT Application No. PCT/GB2023/052740 filed Oct. 20, 2023, which claims priority to GB Application No. 2215641.8 filed Oct. 21, 2022, each of which is hereby incorporated by reference in their entirety.

### TECHNICAL FIELD

The present invention relates to a sheet of aerosol generating material. The present invention also relates to an apparatus for manufacturing the sheet of aerosol generating material and a method of manufacturing the sheet of aerosol generating material. The present invention further relates to a component comprising a rod formed from the sheet of aerosol generating material and an article comprising the component, as well as an apparatus for manufacturing the rod and a method of manufacturing the rod.

### BACKGROUND OF THE INVENTION

It is known to provide articles for use in an aerosol generating device which can be heated to generate and aerosol. The aerosol is drawn downstream by a user to be inhaled and usually passes through a mouthpiece.

### SUMMARY OF THE INVENTION

According to an embodiment of the present invention, there is provided an article comprising: a rod of aerosol generating material; wherein the rod of aerosol generating material is formed from a plurality of elongate strips of aerosol generating material extending longitudinally through said rod; wherein each of the plurality of elongate strips is connected to at least one other of the plurality of elongate strips by a connection portion, wherein the connecting portion comprises over 20% of the length of each elongate strip.

In some embodiments, the connecting portion may comprise less than 40% of the length of each elongate strip of aerosol generating material.

In some embodiments, the plurality of elongate strips may have a length in the longitudinal direction of the article in the range of 2 mm to 15 mm.

In some embodiments, the plurality of elongate strips may have a length in the longitudinal direction of the article in the range of 5 mm to 10 mm.

In some embodiments, the connecting portion may have a length in the longitudinal direction of the article in the range of 23% to 30% of the length of the elongate strip.

In some embodiments, the plurality of elongate strips of aerosol generating material may extend substantially parallel to one another.

In some embodiments, the article may comprise in the range of 10 to 32 elongate strips.

In some embodiments, the connecting portion may be formed by longitudinally extending slits of discrete length in the rod of aerosol generating material such that the connecting portion extends between two longitudinally adjacent slits of discrete length.

In some embodiments, the connecting portions may be located at the same distance in the longitudinal direction from an end of the rod of aerosol generating material.

In some embodiments, the connecting portions may form a band of aerosol generating material from which the plurality of elongate strips of aerosol generating material extend.

In some embodiments, the band of aerosol generating material may extend substantially transversely through the rod of aerosol generating material relative to the longitudinal axis of the rod.

In some embodiments, a first plurality of elongate strips may extend longitudinally downstream of the band of aerosol generating material through the rod of aerosol generating material.

In some embodiments, a second plurality of elongate strips may extend longitudinally upstream of the band of aerosol generating material.

In some embodiments, at least one of the connecting portions may be offset in the longitudinal direction of the rod of aerosol generating material to at least one other of the connecting portions.

In some embodiments, the connecting portions may be located at varying distances in the longitudinal direction from an end of the rod of aerosol generating material.

In some embodiments, the connecting portions may form a band of aerosol generating material which extends helically in the rod of aerosol generating material.

In some embodiments, one of the connecting portions may be offset from the adjacent connecting portions such that the adjacent connecting portions do not overlap in the longitudinal direction of the rod of aerosol generating material.

In some embodiments, adjacent elongate strips of aerosol generating material may be connected by a plurality of connecting portions spaced apart in the longitudinal direction of the rod of aerosol generating material.

In some embodiments, the plurality of elongate strips may have a width in the range of 0.8 mm to 1.2 mm.

In some embodiments, the rod of aerosol generating material may be located upstream of a filter and/or mouthpiece.

According to another aspect of the invention, there is provided an apparatus for manufacturing rods of aerosol generating material of an article for an aerosol generating device component, the apparatus comprising: a first cutter configured to cut an aerosol generating material longitudinally to produce a plurality of elongate strips; wherein the first cutter is configured to cut longitudinally extending slits of discrete length into a sheet of aerosol generating material, wherein the length of the connecting portion is greater than 20% of the length of the slit.

In some embodiments, the length of the connecting portion may be less than 40% of the length of the slit.

In some embodiments, the first cutter may comprise a first cutter array and a second cutter array, wherein each of the first and second cutter arrays may comprise a cutting element.

In some embodiments, the cutting element may comprise a cutting edge at its radial extremity that extends circumferentially around the cutter array on which the cutting element is mounted.

In some embodiments, the cutting element of the first cutter array and the cutting element of the second cutter array may be arranged such that the slits of discrete length are formed by a shearing action between adjacent cutting elements of the first and second cutter arrays.

In some embodiments, the distance between the rotational axes of the first and second cutter arrays may be such that the cutting edges of the first and second cutter arrays overlap to provide the shearing action.

In some embodiments, the cutting element may comprise at least one notch extending in the circumferential direction.

In some embodiments, the at least one notch may comprise a generally circumferentially extending local area of the at least one cutting element that has a smaller radius than the cutting edge.

In some embodiments, the local area of the notch may be configured to discontinue a slit being made into a sheet of aerosol generating material.

In some embodiments, the local area of the at least one notch may be configured to remain out of contact with a sheet of aerosol generating material being cut.

In some embodiments, the notches on adjacent cutting elements of a cutter array may be aligned.

In some embodiments, the notch on one of the cutting elements of the first cutter array may be aligned with the notch on one of the cutting elements of the second cutter array at the point of maximum overlap between the cutter arrays.

In some embodiments, the notch may extend through the whole width of the cutting element.

In some embodiments, the notch may extend through a part of the width of the cutting element and may comprise an opening in a side face of the cutting element to form a partial notch.

In some embodiments, the cutting element may comprise a plurality of partial notches, wherein adjacent partial notches of one cutting element extend into the cutting element from opposing sides of the cutting element.

In some embodiments, the partial notch on one of the cutting elements of the first cutter array may be aligned with one of the partial notches on adjacent cutting elements on the second cutter array at the point of maximum overlap between the cutter arrays.

In some embodiments, the width of the plurality of elongate strips of aerosol generating material may be determined by the width of the cutting elements of the cutter arrays.

In some embodiments, the distance between cutting elements in a cutter array may be substantially in the range of about 0.8 mm to 1.2 mm.

In some embodiments, the distance between cutting elements in a cutter array may be about 1 mm.

In some embodiments the apparatus may further comprises a gatherer configured to gather the sheet of aerosol generating material together to form a rod.

In some embodiments, the apparatus may, further comprises a second cutter configured to cut the rod into segments to produce rods of aerosol generating material.

According to another aspect of the present invention, there is provided a method of forming a rod of aerosol generating material of an article for an aerosol generating device component, the method comprising: cutting an aerosol generating material longitudinally to produce a plurality of elongate strips of aerosol generating material; wherein cutting comprises longitudinally extending slits of discrete length through a sheet of aerosol generating material; gathering the plurality of elongate strips to form a rod of aerosol generating material in which each of the elongate strips extends substantially longitudinally through the rod; and cutting the rod of aerosol generating material into segments to produce rods of aerosol generating material for an aerosol generating device component; wherein the connecting portion comprises over 20% of the length of each elongate strip.

In some embodiments, the connecting portion may comprise less than 40% of the length of each elongate strip of aerosol generating material.

In some embodiments, adjacent connecting portions may be aligned in a plane perpendicular to the longitudinal axis of the rod of aerosol generating material.

In some embodiments, adjacent connecting portions may be offset in the longitudinal direction.

### BRIEF DESCRIPTION OF THE DRAWINGS

So that the invention may be more fully understood, embodiments of the present invention will now be described, by way of example only, with reference to the accompanying drawings, in which:

FIG. 1 shows a schematic top view of a sheet of aerosol generating material;

FIG. 2 shows a schematic cross-sectional view of the sheet of aerosol generating material shown in FIG. 1;

FIG. 3 shows a schematic top view of a sheet of aerosol generating material;

FIG. 4 shows a schematic cross-sectional view of the sheet of aerosol generating material shown in FIG. 3;

FIG. 5 shows a schematic perspective view of a component comprising a sheet of aerosol generating material;

FIG. 6 shows a schematic perspective view of an article comprising a component comprising a sheet of aerosol generating material;

FIG. 7 shows a schematic front view of a first cutter;

FIG. 8 shows a schematic side view of a cutting knife;

FIG. 9 shows a schematic side view of a cutting knife;

FIG. 10 shows a schematic front view of a first cutter;

FIG. 11 shows a schematic front view of a first cutter;

FIG. 12 shows a schematic view of cutting elements of the first cutter shown in FIG. 10 when in an overlapping configuration;

FIG. 13 shows a schematic view of cutting elements of the first cutter shown in FIG. 11 when in an overlapping configuration; and

FIG. 14 shows a schematic side view of an apparatus for manufacturing a rod of aerosol generating material.

### DETAILED DESCRIPTION

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

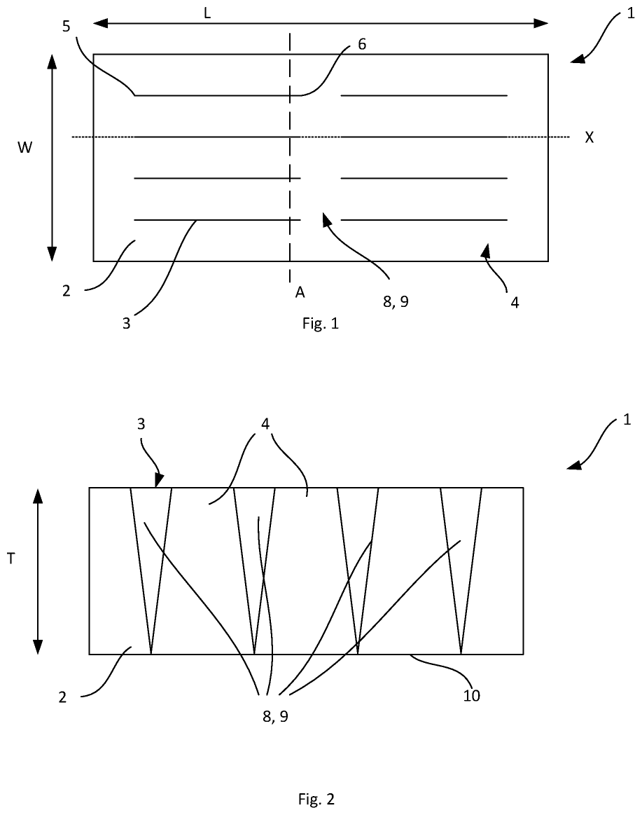

Referring now to FIG. 1, a sheet 1 of aerosol generating material 2 is shown. The aerosol generating material 2 may be any type of aerosol generating material mentioned above. The sheet 1 of aerosol generating material 2 comprises a plurality of elongate partial cuts 3. The plurality of elongate partial slits 3 extend through the thickness T of the sheet 1 of aerosol generating material 2. The thickness T of the sheet 1 of aerosol generating material 2 may be considered the dimension into the page shown in FIG. 1.

The thickness T of the sheet 1 of aerosol generating material 2 may be in the range of about 30 μm to 300 μm. Preferably, paper sheets will have a thickness in the range of 30 to 200 μm and sheets formed from tobacco, of which various are listed above, preferably have a thickness in the range of 50 to 300 μm, The density of the sheet material may be in the range of about 20 to 250 GSM (grams per square meter). Preferably, the various forms of sheet tobacco will have a density in the range of 50 to 250 GSM, whereas dry gel sheets preferably have a density in the range of 50to 200 GSM, and paper sheets preferably have a density in the range of 20 to 200 GSM, more preferably between 20 and 100 GSM. Cellophane and natureflex may have properties more closely related to paper sheets, whilst PLA and HDPE may have properties more closely related to dry gel sheets. In the case of laminates, it will be understood that each layer may have a thickness or density in the ranges described above but that the full thickness of the laminate may be outside the range stated above for a single layer material.

As shown in FIG. 1, the plurality of elongate discrete slits 3 extend in the longitudinal direction L of the sheet 1 of aerosol generating material 2. That is, the plurality of elongate partial slits 3 may substantially extend in the longitudinal direction L of the sheet 1 of aerosol generating material 2. The plurality of elongate partial slits 3 may extend substantially parallel to one another. The plurality of elongate partial slits 3 may extend over a discrete length of the sheet 1 of aerosol generating material 2. That is, each one of the plurality of elongate partial cuts 3 may be discontinuous in the longitudinal direction L of the sheet 1 of aerosol generating material 2.

The plurality of elongate partial slits 3 may be spaced apart in the width direction W of the sheet 1 of aerosol generating material 2. The width direction W is orthogonal with the longitudinal direction L and the thickness T of the sheet 1 of aerosol generating material 2. The plurality of elongate partial slits 3 may be spaced apart in the width direction W of the sheet 1 of aerosol generating material 2 by a distance in the range of 0.8 mm to 1.2 mm. Preferably, the plurality of elongate partial slits 3 are spaced apart in the width direction W of the sheet 1 of aerosol generating material 2 by a distance of 1 mm.

As previously mentioned, the plurality of elongate slits 3 extend through the thickness T of the sheet 1 of aerosol generating material 2 to define a plurality of elongate strips 4. The plurality of elongate slits 3 that extend through the thickness T of the sheet 1 of aerosol generating material 2 make the sheet 1 easier to gather into a rod. That is, the plurality of elongate slits 3 make the sheet 1 easier to form into a cylinder shape when gathered. Without wishing to be bound by theory, it is thought that the separation of the material by the slits through the thickness T of the sheet 1 reduces the connected material between the strips. The reduction in the connections between the strips allows the strips to compress and bend more easily than a non-cut sheet. Referring to FIG. 2, a cross-sectional view along the plane A of the sheet 1 of aerosol generating material 2 of FIG. 1 is shown. It will be understood that the size of width of the plurality of elongate slits 3 has been exaggerated for clarity.

In the present embodiment, the sheet 1 of aerosol generating material 2 may comprise a plurality of discrete longitudinally extending elongate slits 3 through the thickness of the sheet 1 of aerosol generating material 2 that are aligned on the same longitudinally extending axis X. That is, a plurality of longitudinally extending elongate slits 3 are discontinuous in the longitudinal direction L of the sheet 1 of aerosol generating material 2.

The sheet 1 of aerosol generating material 2 may comprise in the range of 10 to 30 elongate slits 3. Thus, the sheet 1 of aerosol generating material 2 may comprise in the range of 12 to 32 partially separated elongate strips 4 of aerosol generating material 2.

Each of the plurality of discrete elongate slits 3 may comprise a first end 5 and an opposing second end 6. The first end 5 of one of the discrete partial cuts 3 may be the end of the discrete slits cut 3 where the cut was initiated. The second end 6 of one of the discrete slits 3 may be the end of the discrete slit 3 where the cut is finished. In FIG. 2, there is shown a cross-sectional view along the plurality of discrete slits 3 at the end of which the first ends 5 of the discrete slits 3 can be seen.

The plurality of elongate discrete slits 3 may be defined by connecting portions 8. That is, a connecting portion 8 may extend between the second end 6 of one of the discrete slits 3 and the first end of an adjacent discrete slit 3 on the same longitudinal axis X. At least one of the connecting portions 8 may have a thickness equal to the thickness T of the sheet 1 of aerosol generating material 2. Preferably, each of the connecting portions 8 may have a thickness equal to the thickness T of the sheet 1 of aerosol generating material 2.

In some embodiments, the connecting portions 8 may have a length in the longitudinal direction L of the sheet 1 of aerosol generating material 2 in the range of 0.2 to 0.4 times the length of one of the plurality of elongate discrete slits 3. Preferably, the connecting portions 8 may have a length in the longitudinal direction L of the sheet 1 of aerosol generating material 2 of at least 20% of the length of one of the plurality of discrete slits 3. In some embodiments, the connecting portions 8 may have a length in the longitudinal direction L of the sheet 1 of aerosol generating material 2 in the range of 23% to 30% the length of one of the plurality of elongate discrete slits 3. This provides an advantage of maintaining the integrity of the plurality of strips as they are pulled through manufacturing apparatus whilst providing increased flexibility of the sheet for forming into a rod.

Although embodiments having connecting portions 8 that have a length in the longitudinal direction L of the sheet 1 of at least 20% of the length of one of the plurality of discrete slits 3 is preferable, it is also optional and it is envisaged that in some embodiments the connecting portions 8 may have length in the longitudinal direction L of the sheet 1 of less than 20% of the length of one of the plurality of discrete slits 3. In such embodiments, an acceptable decrease in integrity of the strips may be traded for increased flexibility of the sheet 1.

In some embodiments, the plurality of elongate partial cuts 3 may have a length in the longitudinal direction of the sheet in the range of 2 mm to 15 mm. In some embodiments, the plurality of elongate partial cuts 3 may have a length in the longitudinal direction of the sheet in the range of 5 mm to 12 mm.

In some embodiments, the length of an elongate partial cut 3 in the longitudinal direction of the sheet may be between 1 mm and 40 mm. In some embodiments, the length of an elongate partial cut 3 in the longitudinal direction of the sheet may be between 5 mm and 10 mm. In some embodiments, the second connecting portions 25 may have a length in the longitudinal direction L of the sheet 21 of aerosol generating material 2 in the range of 0.1 mm to 16 mm or in the range of 0.2 mm to 12 mm. In some embodiments, the second connecting portions 25 may have a length in the longitudinal direction L of the sheet 21 of aerosol generating material 2 in the range of 0.5 mm to 4 mm or in the range of 1 mm to 3 mm.

In the present embodiment, the connecting portions 8 are aligned adjacent to each other across the width of the sheet 1 of aerosol generating material 2. That is, the connecting portions 8 between adjacent discrete slits 3 on the same longitudinal axis X are located at the same location in the longitudinal direction as the connecting portions 8 between adjacent discrete slits 3 on the same adjacent longitudinal axis X′. Adjacent discrete slits 3 may have their first ends 5 located in the same longitudinal position and may have their second ends 6 located in the same longitudinal position but spaced widthwise from each other. The connecting portions 8 may be aligned such that a band 9 of aerosol generating material 2 extends transversely across the sheet 1 of aerosol generating material 2, i.e. perpendicularly to the elongate discrete slits 3.

It will be appreciated that the sheet 1 of aerosol generating material 2 may comprise a plurality of connecting portions 8 in a longitudinal plane that extends orthogonally to a major surface of the sheet 1 of aerosol generating material 2. The major surface of the sheet 1 of aerosol generating material 2 may be, for example, the bottom surface 10.

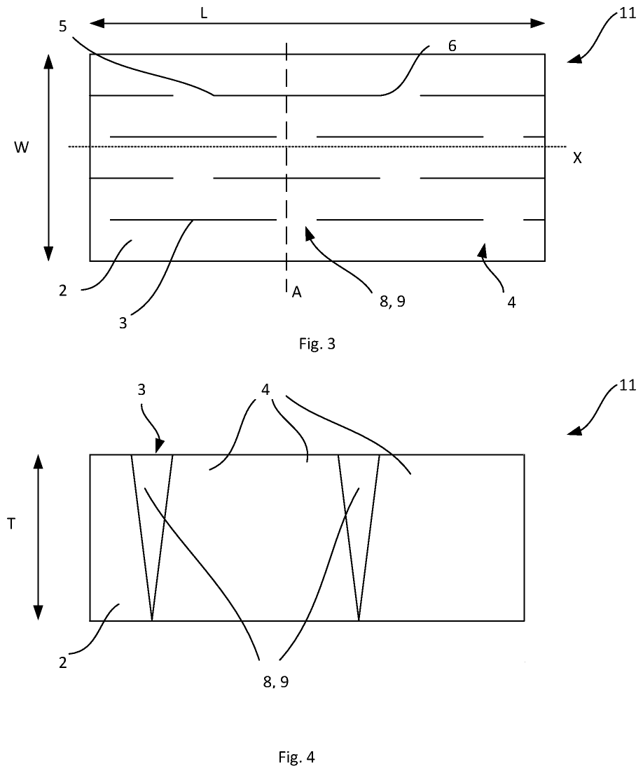

Referring now to FIGS. 3 and 4, a second embodiment of a sheet 11 of aerosol generating material 2 is shown. The embodiment of the sheet 11 of aerosol generating material 2 shown in FIGS. 3 and is generally the same as the sheet 1 of aerosol generating material 2 shown in FIGS. 1 and 2, so a detailed description thereof will be omitted herein. Furthermore, similar features and components will retain their terminology and reference numerals.

The sheet 11 of aerosol generating material 2 shown in FIGS. 3 and 4 is different to the sheet 1 of aerosol generating material 2 shown in FIGS. 1 and 2 in that at least one of the connecting portions 8 is offset in the longitudinal direction L of the sheet 11 of aerosol generating material 2 relative to at least one other of the connecting portions 8.

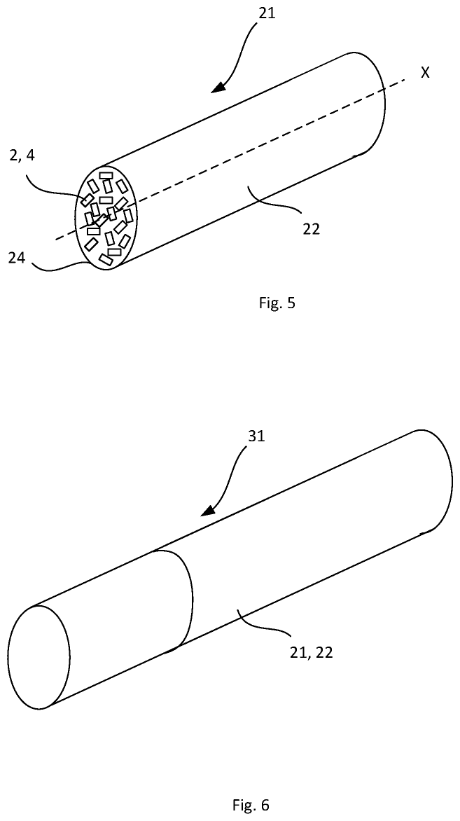

Referring now to FIG. 5, a component 21 for an aerosol generating device is shown. The component 21 comprises a rod 22 of aerosol generating material 2 comprising a plurality of elongate strips 4 of aerosol generating material 2 extending longitudinally through the rod 22. The plurality of elongate strips 4 of aerosol generating material 2 are formed by partially cutting a sheet 1, 11 of aerosol generating material 2 in the longitudinal direction.

Each of the plurality of elongate strips 4 may have a width in the range of 0.8 mm to 1.2 mm. Preferably, each of the elongate strips 4 may have a width of 1 mm.

In some embodiments, the plurality of elongate strips 4 of aerosol generating material 2 may be formed by partially cutting the sheet 1, 11 of aerosol generating material 2 in the longitudinal direction, such that the adjacent elongate strips are connected by at least one connection portion 8 of aerosol generating material 2.

The rod 22 of aerosol generating material 2 may comprise connecting portions 8 of aerosol generating material 2 that form a band 9 of aerosol generating material 2. The plurality of elongate strips 4 may extend from the band 9 of aerosol generating material 2. The plurality of elongate strips 4 of aerosol generating material 2 and the band 9 of aerosol generating material may be integrally formed and cut from the same sheet 1, 11 of aerosol generating material 2.

In the present embodiment, the band 9 of aerosol generating material 2 extends transversely to the plurality of elongate strips 4 of aerosol generating material 2, i.e. perpendicularly to the longitudinal axis A of the component 21. The connecting portions 8 that form the band 9 of aerosol generating material 2 may be located as the same distance in the longitudinal direction from an end 24 of the rod 22 of aerosol generating material 2. That is, the band 9 may extend substantially in a plane comprising a circumference of the rod 22 of aerosol generating material 2.

However, the sheet 1 of aerosol generating material 2 is to be gathered in a manner in which it is folded randomly and so is not likely to be arranged in a circular or spiral pattern within the component 21, although it could be in some embodiments. In an alternative embodiment, the band 9 of aerosol generating material 2 may extend at an acute angle to the longitudinal axis A of the rod 22 of aerosol generating material 2 or in any offset, or alternating, pattern when formed from the sheet 11 of aerosol generating material 2 shown in FIGS. 3 and 4. That is, the connecting portions 8 of aerosol generating material 2 may be offset in the longitudinal direction of the rod 22 of aerosol generating material 2 to at least one other of the connecting portions 8, especially to a connecting portion 8 between discrete longitudinal slits 3 on a transversely adjacent discrete slit 3.

It will be appreciated that the rod 22 of aerosol generating material 2 may comprise a plurality of bands 9 of aerosol generating material 2 that are longitudinally spaced apart within the rod 22 of aerosol generating material 2.

The band 9 of aerosol generating material 2 may have a thickness substantially equal to the thickness of the sheet 1, 11 of aerosol generating material 2. In some embodiments, the connecting portions 8 or band 9 of aerosol generating material 2 extend longitudinally over at least 20% of the length of each elongate strip 4. In some embodiment, the connecting portions 8 or band 9 of aerosol generating material 2 extend longitudinally over less than 40% of the length of each elongate strip 4.

In some embodiments, the connecting portions 8 or band 9 of aerosol generating material 2 may have a longitudinal length of 0.2 to 0.4 times the length of an elongate strip 4 of aerosol generating material 2. An elongate strip 4 of aerosol generating material 2 may be considered to be the pitch between the first ends 5 of two adjacent discrete slits 3 in the longitudinal direction. In some embodiments, the connecting portions 8 or band 9 of aerosol generating material 2 may have a longitudinal length of 0.2 to 0.4 times the length of the discrete longitudinal 3 cut through the sheet 1, 11 of aerosol generating material 2.

Referring briefly to FIG. 6, there is shown an article 31 comprising the component 21 comprising a rod 22 of aerosol generating material 2 formed from a sheet 1, 11 of aerosol generating material 2, as described above. The article 31 may be an article for an aerosol generating device (not shown).

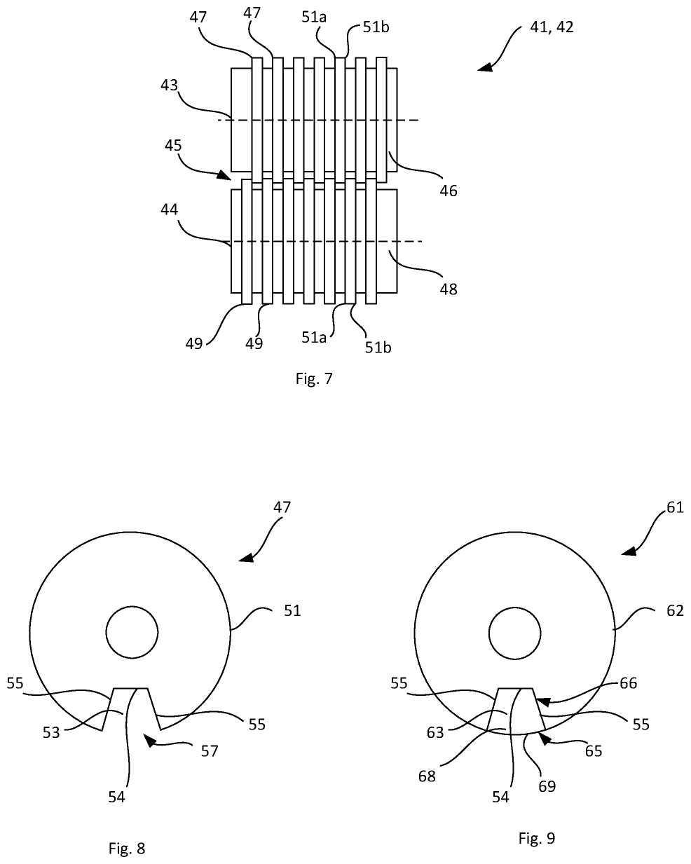

Referring now to FIG. 7, there is shown a schematic front view of an apparatus 41 for manufacturing a sheet 1, 11 of aerosol generating material 2. The apparatus 41 comprises a first cutter 42. The first cutter 42 is configured to cut a sheet 1, 11 of aerosol generating material longitudinally to produce a plurality of elongate strips 4.

The first cutter 42 may comprises a first cutter array 43 and a second cutter array 44. The first cutter array 43 and the second cutter array 44 may be arranged such that the slits 3 of discrete length are formed by a shearing action. That is, the first cutter array 43 and the second cutter array 44 may be arranged such that they overlap with one another over a portion of their periphery.

In some embodiments, the first cutter array 43 may comprises a first drum 46 and a cutting element 47. The first drum 46 may be generally cylindrical and may be configured to rotate about its longitudinal axis. The cutting element 47 may extend from the first drum 46 is a direction substantially perpendicular to the longitudinal axis of the first drum 46. The cutting element 47 may be configured to cut slits 3 of discrete length into a sheet 1,11 of aerosol generating material 2. That is, the first cutter array 44 comprises at least one cutting element 47 which is configured to cut longitudinal slits 3 of discrete length through a sheet 1, 11 of aerosol generating material 2.

In the present embodiment, the first cutter array 43 of the first cutter 42 comprises a plurality of cutting elements 47. The cutting elements 47 are mounted to the first drum 46, which rotates each of the cutting elements 47 at the same angular velocity. The first drum 46 extends transversely to the longitudinal direction of sheet 1, 11 of aerosol generating material 2. That is, the first drum 46 is configured to extend across the width of the sheet 1, 11 of aerosol generating material 2 when the sheet 1, 11 of aerosol generating material 2 is passed through the first cutter 42 to be partially cut in the thickness direction.

In some embodiments, each of the plurality of cutting elements 47 of the first cutter array 43 may be separated from an adjacent cutting element 47 of the first cutter array 43 by a distance in the range of between 0.5 mm and 2 mm. In some embodiments, each of the plurality of cutting elements 47 of the first cutter array 43 may be separated from an adjacent cutting element 47 of the first cutter array 43 by a distance in the range of between 0.8 mm and 1.2 mm. In some embodiments, each of the plurality of cutting elements 47 of the first cutter array 43 may be separated from an adjacent cutting element 47 of the first cutter array 43 by a distance of about 1 mm.

In the present embodiment, the second cutter array 44 of the first cutter 42 comprises a second drum 48 and a cutting element 49. The second cutter array 44 is generally the same as the first cuter array 44 as described above and so a detailed description thereof will be omitted herein. The second drum 48 is generally cylindrical and has a longitudinal axis that extends parallel to the longitudinal axis of the first drum 46. The second cutter array 48 may comprise at least one cutting element 49, which is configured to cut longitudinal slits 3 of discrete length through a sheet 1, 11 of aerosol generating material 2.

The second drum 48 may configured to rotate about its longitudinal axis and may be arranged to rotate in the opposite direction to the first drum 46. The distance between the rotational axes of the first cutter array 44 and the second cutter array 68 may be configured such that the cutting elements 47, 49 of the first and second cutter arrays 44, 48 overlap to provide a shear cutting action, as will be described in more detail hereinafter. The region of overlap is denoted by reference numeral 45.

In some embodiments, the distance, in a direction parallel to the drums axes of rotation, between a cutting element 47 on the first cutter array 43 and a cutting element 49 on the second cutter array 44 may be in the range of 50 microns to 150 microns. When the gap between a cutting element 47 on the first cutter array 43 and a cutting element 49 on the second cutter array 44 is 50 microns, the cut formed in the sheet 1 of aerosol generating material 2 is a ‘clean’ cut, with a relatively low roughness. As the gap between a cutting element 47 on the first cutter array 43 and a cutting element 49 on the second cutter array 44 is increased, the surfaces formed by a cutting tool become more rough.

In some embodiments, the distance between one cutting element 47 on the first cutter array 43 and one cutting element 49 on the second cutter array 44 may be different to the distance between another cutting element 47 on the first cutter array 43 and another cutting element 49 on the second cutter array 44. In this way, elongate strips 4 having different widths can be formed from the same sheet 1 of aerosol generating material 2. In some embodiments, the distance between cutting elements 47 on the first cutter array 43 and cutting elements 49 on the second cutter array 44 may be adjustable.

Referring now to FIG. 8, a schematic side view of a cutting element 47 is shown. The cutting element 47, 49 is representative of a cutting element 47, 49 that can be used on the first cutter array 44 and the second cutter array 48. In the present embodiment, each cutting element 47, 49 comprises a generally annular cutting disk. In some embodiments, each cutting element 47, 49 may be circular or the first and second cutter arrays 44, 48 of the first cutter 42 may comprise a combination of generally annular and generally circular cutting elements 47, 49.

Each of the cutting elements 47, 49 may comprise a cutting edge 51. The cutting edge 51 may extend around a periphery of the cutting element 47, 49. Thus, in the present embodiment, the cutting edge 51 is arcuate. The cutting edge 71 may extend circumferentially. That is, the cutting edge 51 of the cutting element 47, 49 is located at its radial extremity and extends circumferentially around the drum 46, 48 of the cutter array 43, 44 that is mounted on. However, the cutting edge 51 is configured to be discrete in length or discontinuous. That is, the cutting edge 51 does not extend circumferentially about a full 360 degrees.

The cutting edge 51 of the cutting element 47, 49 is configured to cut discrete longitudinally extending slits 3 in a sheet 1, 11 of aerosol generating material 2. That is, the cutting element 47 of the first cutter array 43 and the cutting element 49 of the second cutter array 44 are arranged such that the slits 3 of discrete length are formed by a shearing action between adjacent elements 47, 49 of the first and second cutter arrays 43, 44. The shearing action is provided by locating the rotational axes of the first and second cutter arrays 44, 46 at a distance that is less than the combined radii of the cutting edge 51 of the cutting elements 47, 49 on the first and second drums 46, 48, such that the cutting edges 51 of the first and second cutter arrays 43, 44 overlap 45.

In this case, the term overlap 45 is used to denote a point, or area, where the cutting edge 51 of the cutting element(s) 47 on the first drum 44 of the first cutter array 43 is closer to the rotational axes of the second drum 48 of the second cutter array 44. Simultaneously, when the cutting elements 47, 49 overlap, the cutting edge 51 of the cutting element(s) 49 on the second drum 48 of the second cutter array 44 is closer to the rotational axes of the first drum 46 of the first cutter array 43.

That is, referring back to FIG. 7, the cutting elements 47, 49 of the first and second cutter arrays 43, 44 may be positioned along their respective drums 46, 48 such that the cutting elements 47, 49 from the first and second cutter arrays 43, 44 alternate across the width of the first cutter 41. In other words, a cutting element 49 of the second cutter array 44 is located in between adjacent cutting elements 47 of the first cutter array 43 and a cutting element 47 of the first cutter array 43 is located in between adjacent cutting elements 49 in the second cutter array 44.

In the present embodiment, the plurality of cutting elements 47, 49 of the first and second cutter arrays 43, 44 are spaced apart evenly from one another. That is, adjacent cutting elements 47 of the first cutter array 43 are spaced apart evenly and adjacent cutting elements 49 of the second cutter array 44 are spaced apart evenly. Furthermore, cutting elements 47 of the first cutter array 43 and spaced evenly apart from the cutting elements 49 of the second cutter array 44. That is, the distance between adjacent cutting elements 47, 49 may be the same.

The width of the plurality of elongate strips 4 of aerosol generating material 2 is determined by the width of the cutting elements 47, 49 of the cutter arrays 43, 44. That is, the cutting edges 51 of the cutting elements 47, 49 are located proximate to each other in order to carry out a shear cut. Thus, the cutting edge 51 comprises a first cutting edge portion 51a and a second cutting edge portion 51b; one on each side of the cutting edge 51 of the cutting elements 47, 49 proximate to an adjacent cutting element 49, 47 on the opposing array 43, 44.

The first cutting edge portion 51a is on one side of the cutting element 47, 49 and the second cutting edge portion 51b is on the opposing side of the cutting element 47, 49 with respect to the width of the cutting element 47, 49. The first cutting edge portion 51a on a cutting element 47 of the first cutter array 43 is configured to cooperate with an adjacent cutting element 49 of the second cutter array 44 to provide a shear cut and the second cutting edge portion 51b is configured to cooperate with an adjacent cutting element 49 of the second cutter array 44 on the other side of the cutting element 47 of the first cutter array 43 to provide two distinct shear cuts and thus a elongate strip 4 of aerosol generating material 2.

Thus, a single cutting element 47, 49 cuts the sheet 1, 11 of aerosol generating material 2 twice by performing two shear cuts with a cutting edge 51 of two separate cutting elements 47, 49 on the opposing cutter array 43, 44. The distance between the cutting edges 51 on a single cutting element 47, 49 therefore determines the width of the strip 4 cut.

It will be understood that in some embodiments, the cutting element 47, 49 may have an annular, or circular, shape formed by a plurality of arcuate, or sector shaped, segments rather than an integral piece. In such an embodiment, the cutting edges 51 are arcuate and extend circumferentially and combine to form a cutting edge 51.

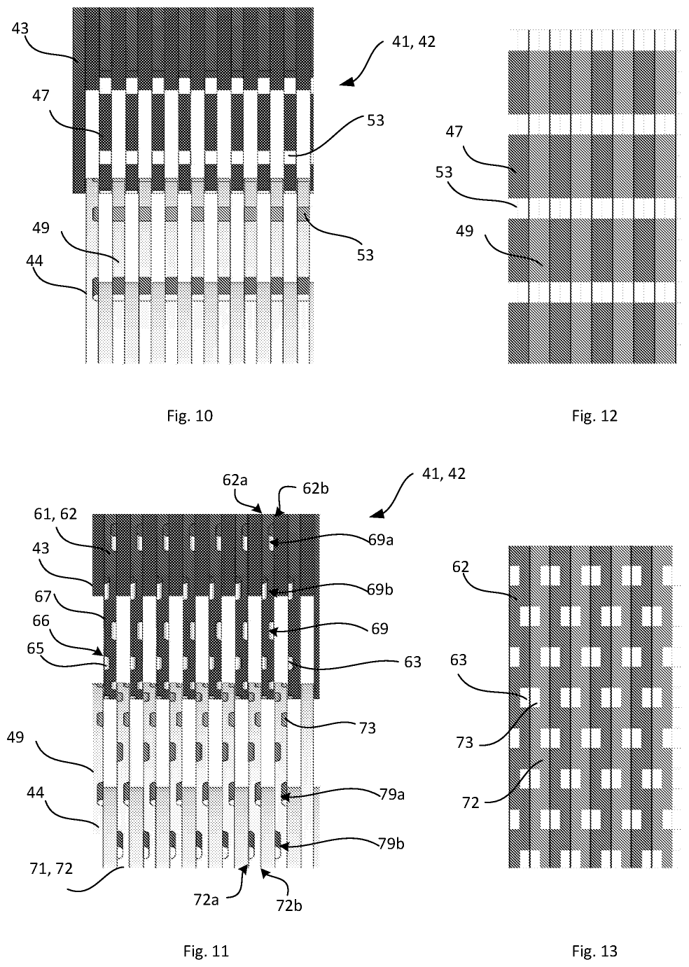

Referring now to FIGS. 8 and 10, in the present embodiment, the cutting element 47, 49 comprises a notch 53 or cut-out section. The notch 53 may extend in the circumferential direction. In some embodiments such as that shown in FIG. 8, the notch 53 may be formed by completely removing all the material of the cutting element 47, 49 from a sector of the cutting element 47, 49. That is, the notch 53 may extend through the whole width of the cutting element 47, 49. In some embodiments, the notch 53 may be configured to provide a generally circumferentially extending local area 54 of the at least one cutting element 47, 49 that has a smaller radius than the cutting edge 51.

The notch 53 may extend over a central angle of between 10 to 90 degrees. In some embodiments, the notch 53 may be sector shaped. In some embodiments, the notch 53 may be in the shape of a truncated notch or generally square or rectangular. In such an embodiment, the cutting element 47, 49 may comprise a cutting edge 51 and a local area 54 that extends generally concentrically with the cutting edge 51 but having a smaller radius, such that it is closer to the longitudinal axis of rotation of the first or second drum 46, 48 than the cutting edge 51.

In some embodiments, the local area 54 of the notch 53 of the cutting element 47, 49 may have such a small radius that the local area 54 of the notch 53 does not contact the sheet 1, 11 of aerosol generating material 2. In some embodiments, the local area 54 of the notch 53 may contact the sheet 1, 11 of aerosol generating material 2. In such embodiments, the local area 54 of the notch 53 may be configured to discontinue a discrete elongate slit 3 being made into the sheet 1, 11 of aerosol generating material 2. The local area 54 of the notch 53 may be connected to the cutting edge 51 by substantially radially extending portions 55.

Therefore, the arcuate cutting edge 51 comprises a gap 57. That is, the arcuate cutting edge 51 is discontinuous. The gap 57 in the arcuate cutting edge 51 is configured not to cut a sheet 1, 11 of aerosol generating material 2 as it passes through the first cutter 41.

In the present embodiment, the notch 53 in the cutting element 47, 49, which causes the gap 57 in the cutting edge 51, is shown as a sector of the cutting element 47, 49 that has been removed. However, it will be appreciated that in alternative embodiments, the notch 53, or cut-out section, may be a different shapes, such as for example, but not limited to, square or rectangular, a segment, a triangle, or semi-circle, etc.

The cutting element 47, 49 may comprise a plurality of notches 53, as shown in FIGS. 10 and 12. The plurality of notches 53 may be equally spaced around the circumference of the cutting element 47, 49. Thus, the cutting edge 51 of the cutting element 47, 49 may have more than one gap 57 and more than one local area 54, which is configured to not cut a sheet 1, 11 of aerosol generating material 2. In such an embodiment, the cutting edge 51 may be split into a plurality of parts which each cut a slit 3 of discrete length into a sheet 1, 11 of aerosol generating material 2.

In some embodiments, notches 53 on adjacent cutting elements 47, 49 of a cutter array 43, 44 are aligned, as shown in FIG. 10. Alignment of the notches 53 of each of the cutting elements 47, 49 of the first and second cutter arrays 43, 44 in the overlapping portion 45 can be seen schematically in FIG. 12. In some embodiments, the notches 53 on adjacent cutting elements 47 on the first cutter array 43 are aligned and the notches on adjacent cutting elements 49 on the second cutter array 44 are aligned. Furthermore, a notch 53 on the cutting elements 47 on the first cutter array 43 may be aligned with a notch 53 on the cutting elements 49 on the second cutter array 44 at the point of maximum overlap between the cutter arrays 43, 44. The point of maximum overlap lies in the planes that extends between the rotational axes of the drums 46, 48 of the cutter arrays 43, 44.

Therefore, the aligned notches 53 in the cutting elements 47 and the aligned gaps 57 in the cutting edge 51 allow a section of the sheet 1 to remain uncut, i.e. the connecting portions 8 described above. The uncut sections, i.e. connecting portions 8, form a band 9 of aerosol generating material 2 running across the width of the sheet 1 of aerosol generating material 2, perpendicular to the longitudinal direction of the elongate slits 3 of discrete length through the sheet 1 of aerosol generating material 2, as previously described with reference to FIG. 1.

Referring briefly to FIGS. 9, an embodiment of a cutting element 61 is shown. The cutting element 61 is also shown in FIG. 11. The cutting element 61 shown in FIGS. 9 and 11 is generally the same as the cutting element 47, 49 shown in FIGS. 8 and 10 so the terminology of similar features and components will remain the same. The main difference between the cutting element 61 shown in FIG. 9 and the cutting element 47, 49 shown in FIG. 9 is the width of the notches therein, as will be explained in more detail hereinafter.

The cutting element 61 comprises a cutting edge 62. The cutting edge 62 extends generally circumferentially. The cutting edge 62 comprises a first cutting edge portion 62a and a second cutting edge portion 62b. Furthermore, the cutting edge 62 comprises a plurality of notches 63. However, in the present embodiment, the plurality of notches 63 comprise a plurality of partial notches 63. That is, the plurality of partial notches 63 extend through a part of the width of the cutting element 61, rather than through the whole width of the cutting element 47, 49 as shown in FIG. 8. The partial notch 63 comprises a local area 64 that extends generally concentrically with the cutting edge 62 but having a smaller radius, such that it is closer to the longitudinal axis of rotation of the first or second drum 46, 48 than the cutting edge 62.

Therefore, the partial notch 63 comprises a first opening 65 in the cutting edge 62 of the cutting element 61 and a second opening 66 in a side face 67 of the cutting element 61. From the side on view of FIG. 9, an interior surface 68 or notch side wall can be seen. Thus, the cutting edge 62 of the cutting element 61 comprises a profiled portion 69 formed by the notches 63. The profiled portion 69 may be continuous.

The cutting element 61 may comprise a plurality of partial notches 63, as shown in FIGS. 11 and 13. The plurality of partial notches 63 may be equidistantly spaced around the circumference of the cutting element 61. In some embodiments, adjacent partial notches 63 of one cutting element 61 may extend into the cutting element 61 from opposing sides of the cutting element 61. That is, a first profiled portion 69a may be located in the first cutting edge portion 62a and a second profiled portion 69b may be located in the second cutting edge portion 62b and spaced circumferentially from the first profiled portion 69a.

It will be understood that the profiled portion 69 may take any shape, such as, for example, but not limited to, U-shaped, V-shaped, semi-circular, triangular, square, or rectangular.

Referring briefly to FIG. 11, an embodiment of the first cutter is shown. It can be seen that both cutter arrays 43, 44 comprise the cutting elements 61, 71 shown in FIG. 9. In such an embodiment, a partial notch 63 on one of the cutting elements 61 on the first cutter array 43 may be aligned with one of the partial notches 73 on an adjacent cutting element 71 on the second cutter array 44 at the point of maximum overlap. Therefore, during rotation, the two notches 63, 73 coincide on the sheet 11 of aerosol generating material 2 which results in a section of aerosol generating material 2 that is not cut and so forms a connecting portion 8, as shown in FIGS. 11 and 13.

It will be understood that partial notches 63 formed in the first cutting edge portion 62a of the cutting edge 62 on adjacent cutting elements 61 on the first cutter array 43 may be aligned and configured to align with partial notches 73 formed on the second cutting edge portion 72b of the cutting edge 71 on the second cutter array 44, which may be aligned with other partial notches 73 formed in the second cutting edge portion 72a of the cutting edge 72 on adjacent cutting elements 71 on the second cutter array 44.

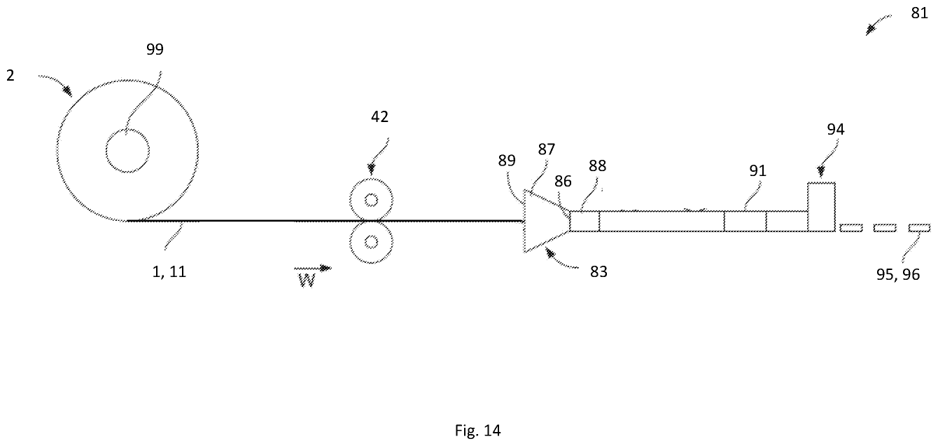

Referring now briefly to FIG. 14, a schematic side view of an apparatus 81 for manufacturing rods of aerosol generating material for an aerosol generating device component is shown. The apparatus 81 comprises the first cutter 42 of the apparatus 41 described above, and so a detailed description thereof will be omitted herein.

The apparatus 81 further comprises a gatherer 83 configured to gather a sheet 1, 11 of aerosol generating material 2, as described above, together to form a rod 84. The rod 84 may be continuous. The plurality of elongate strips 4 extend generally longitudinally through the rod 84.

FIG. 16 shows a schematic side view of the gatherer 83. The gatherer 83 is configured to gather the plurality of elongate strips 4 of aerosol generating material 2 to form a rod 84. In the present embodiment, the gatherer 83 is in the form of a funnel 86. The funnel 86 comprises a funnel portion 87 and a stem portion 88. The funnel portion 87 and the stem portion 88 may be circular is cross section and may be co-axial. The funnel 86 may be symmetrical about its central axis. The funnel portion 87 may narrow from a relatively wide mouth 89 to the relatively narrow stem portion 88.

The sheet 1, 11 of aerosol generating material travels through the funnel 86 from the funnel portion 87 to the stem portion 88. As the cut sheet 1, 11 of aerosol generating material 2 travels through the funnel 91, the narrowing diameter of the funnel portion 87 gathers the partially cut sheet 1, 11 of aerosol generating material 2 together to form a continuous rod 84. As the diameter of the funnel portion 87 narrows, the sheet 1, 11 of aerosol generating material 2 is caused to fold in on itself.

In some embodiments, the gatherer 83 may be formed by a tray (not shown) having one end narrower than the other end. Therefore, the gatherer 83 may have more of a rectangular or triangular shape than the cone shaped funnel 86 described above.

The apparatus 81 may further comprise a wrapping station 91. The wrapping station 91 may be configured to wrap a continuous sheet of wrapping paper around a circumference of the continuous rod 84 of aerosol generating material 2. The wrapping station 91 may also apply adhesive to the wrapping material to seal the wrapping material in place around the rod 84 of aerosol generating material 2. Thus, once the continuous rod 84 of aerosol generating material 2 has passed through the wrapping station 91, the apparatus has formed a continuous component for an aerosol generating device.

The apparatus 81 further comprises a second cutter 94. The second cutter 94 is configured to cut the rod 84 of aerosol generating material 2 into segments 95 to produce rods 42 of aerosol generating material 2. When the apparatus comprises the wrapping station 91, the second cutter 94 is configured to cut the continuous wrapped rod 84 of aerosol generating material into wrapped segments 96, which form the components 41 described above.

As shown in FIG. 14, the aerosol generating material 2 may be stored as a web of aerosol generating material 2 wound around and stored on a bobbin 99.

Although the method of forming a rod of aerosol generating material 2 has generally been described above, the method will now be specifically described for completeness. The method comprises cutting a sheet 1, 11 of aerosol generating material 2 longitudinally to produce a plurality of elongate strips 4 of aerosol generating material. Cutting the sheet 1, 11 of aerosol generating material 2 comprises cutting longitudinally extending slits 3 of discrete length through a sheet 1, 11 of aerosol generating material 2.

In some embodiments, the step of cutting the sheet 1, 11 of aerosol generating material 2 comprises partially cutting through the thickness of the sheet 1,21,31 of aerosol generating material 2 to define a plurality of partially separated elongate strips 4 connected by a first connecting portion 7 having a thickness in the range of 5 μm to 60 μm.

The step of partially cutting the sheet 1, 11 of aerosol generating material 2 in the longitudinal direction may comprise partially cutting along the length sheet 1, 11 to define a plurality of connecting portions 8 having a length in the longitudinal direction of the sheet 1, 11 of over 20% the length of each elongate strip 4. In some embodiments, the connecting portions 8 have a length in the longitudinal direction of the sheet 1, 11 of less than 40% of the length of each elongate strip 4.

In some embodiments, the step of partially cutting along the length sheet 1 to define a plurality of connecting portions 8 may comprise cutting the sheet 1, 11 of aerosol generating material 2 such that second connecting portions 8 in the widthwise direction are aligned. In some embodiments, the step of partially cutting along the length sheet 11 to define a plurality of connecting portions 8 may comprise cutting the sheet 31 of aerosol generating material 2 such that adjacent connecting portions 8 in the widthwise direction are offset in the longitudinal direction.

The method may further comprise gathering the sheet 1, 11 of aerosol generating material to form a rod 84 of aerosol generating material. The method may further comprise cutting the rod 84 of aerosol generating material 2 into segments 95 to produce rods 42 of aerosol generating material 2 for an aerosol generating device component.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the inventions as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be in the future.

1. An article comprising:
a rod of aerosol generating material;
wherein the rod of aerosol generating material is formed from a plurality of elongate strips of aerosol generating material extending longitudinally through said rod;
wherein each of the plurality of elongate strips is connected to at least one other of the plurality of elongate strips by a connection portion,
wherein the connecting portion comprises over 20% of the length of each elongate strip.

2. The article according to claim 1, wherein the connecting portion comprises less than 40% of the length of each elongate strip of aerosol generating material.

3. The article according to claim 1, wherein the plurality of elongate strips have a length in the longitudinal direction of the article in the range of 2 mm to 15 mm.

4. The article according to claim 1, wherein the plurality of elongate strips have a length in the longitudinal direction of the article in the range of 5 mm to 10 mm.

5. The article according to claim 1, wherein the connecting portion has a length in the longitudinal direction of the article in the range of 23% to 30% of the length of the elongate strip.

6. The article according to claim 1, wherein the plurality of elongate strips of aerosol generating material extend substantially parallel to one another.

7. The article according to claim 1, wherein the connecting portion is formed by longitudinally extending slits of discrete length in the rod of aerosol generating material such that the connecting portion extends between two longitudinally adjacent slits of discrete length.

8. The article according to claim 1, wherein the connecting portions are located at the same distance in the longitudinal direction from an end of the rod of aerosol generating material.

9. The article according to claim 8, wherein the connecting portions form a band of aerosol generating material from which the plurality of elongate strips of aerosol generating material extend.

10. The article according to claim 9, wherein the band of aerosol generating material extends substantially transversely through the rod of aerosol generating material relative to the longitudinal axis of the rod.

11. The article according to claim 1, wherein at least one of the connecting portions is offset in the longitudinal direction of the rod of aerosol generating material to at least one other of the connecting portions.

12. An apparatus for manufacturing rods of aerosol generating material of an article for an aerosol generating device component, the apparatus comprising:
a first cutter configured to cut an aerosol generating material longitudinally to produce a plurality of elongate strips;
wherein the first cutter is configured to cut longitudinally extending slits of discrete length into a sheet of aerosol generating material, wherein the length of the connecting portion is greater than 20% of the length of the slit.

13. The apparatus according to claim 12, wherein the length of the connecting portion is less than 40% of the length of the slit.

14. The apparatus according to claim 12, wherein the first cutter comprises a first cutter array and a second cutter array, wherein each of the first and second cutter arrays comprise a cutting element.

15. The apparatus according to claim 14, wherein the cutting element comprises a cutting edge at its radial extremity that extends circumferentially around the cutter array on which the cutting element is mounted.

16. The apparatus according to claim 12, wherein the cutting element of the first cutter array and the cutting element of the second cutter array are arranged such that the slits of discrete length are formed by a shearing action between adjacent cutting elements of the first and second cutter arrays.

17. The apparatus according to claim 16, wherein distance between the rotational axes of the first and second cutter arrays is such that the cutting edges of the first and second cutter arrays overlap to provide the shearing action.

18. The apparatus according to claim 14, wherein the cutting element comprises at least one notch extending in the circumferential direction.

19. The apparatus according to claim 18, wherein the at least one notch comprises a generally circumferentially extending local area of the at least one cutting element that has a smaller radius than the cutting edge.

20. The apparatus according to claim 18, wherein the local area of the notch is configured to discontinue a slit being made into a sheet of aerosol generating material.

21. The apparatus according to claim 18, wherein the local area of the at least one notch is configured to remain out of contact with a sheet of aerosol generating material being cut.

22. The apparatus according to claim 18, wherein the notch on one of the cutting elements of the first cutter array is aligned with the notch on one of the cutting elements of the second cutter array at the point of maximum overlap between the cutter arrays.

23. The apparatus according to claim 22, wherein the notch extends through the whole width of the cutting element.

24. The apparatus according to claim 22, wherein the notch extends through a part of the width of the cutting element and comprises an opening in a side face of the cutting element to form a partial notch.

25. A method of forming a rod of aerosol generating material of an article for an aerosol generating device component, the method comprising:
cutting an aerosol generating material longitudinally to produce a plurality of elongate strips of aerosol generating material;
wherein cutting comprises longitudinally extending slits of discrete length through a sheet of aerosol generating material;
gathering the plurality of elongate strips to form a rod of aerosol generating material in which each of the elongate strips extends substantially longitudinally through the rod; and
cutting the rod of aerosol generating material into segments to produce rods of aerosol generating material for an aerosol generating device component;
wherein the connecting portion comprises over 20% of the length of each elongate strip.
